(19) United States
(12) Patent Application Publication
(10) Pub. No.: US 2009/0031963 A1
(43) Pub. Date: Feb. 5, 2009

(54) CALF WARMING DEVICE AND METHOD OF USING THE SAME

(76) Inventor: Carl Reiste, Adel, IA (US)

Correspondence Address: ZARLEY LAW FIRM P.L.C., CAPITAL SQUARE, 400 LOCUST, SUITE 200, DES MOINES, IA, 50309-2350, US

(21) Appl. No.: 11/831,332

(22) Filed: Jul. 31, 2007

(51) Int. Cl. A01K 1/02; A01K 29/00; H05B 3/00

(52) U.S. Cl. 119/309; 119/308; 119/482

(57) ABSTRACT

A calf warming device having a housing that encloses a newborn calf therein. A base member of the housing comprises a heated surface while sidewalls contain scent openings. Along with the scent openings the housing has at least a transparent portion such that when the calf is warming a mother cow can not only see her calf but additionally smell her calf to ensure the mother cow does not reject the baby calf after the warming process.

### BACKGROUND OF THE INVENTION

This invention relates to warming animals. More specifically, this invention relates to a device for warming a newborn calf.

When newly born calves are born in the winter often times the mother cow is unable to keep the calf sufficiently warm causing the calf to die. As a result, calf warming devices have been made where, upon the birth of a calf, the calf is placed within the calf warming device to keep warm during the initial hours of its life until the calf is able to survive in the outside environment.

Many problems are associated with these calf warming machines. For example, these calf warming machines have a two-step process for warming the calf, the first of which involves drying the calf. However, drying a calf is unsatisfactory because to dry the calf air must be blown onto the calf and this blowing air actually cools and consequently endangers the calf.

Another problem associated with calf warming machines is that when the calf is placed in the device the mother cow can neither see nor smell the calf such that when the calf finally emerges from the calf warming device the mother cow will not recognize the calf as its own. Therefore, the mother cow will refuse to feed and take care of the calf as its own. Another problem is that these machines are difficult and time consuming to clean. This limits the amount of calves that can be attended to by veterinarians using the machine.

An additional problem exists in that calf warming devices and power sources are not portable. Specifically, often a mother cow will not be willing to move from the spot where her water breaks to nurse and tend to the baby calf. As a result there is a need to have a calf warming machine that can be transported to the place the mother cow's water breaks.

Therefore, it is a principal object of the present invention to provide a calf warming device that improves efficiency in warming a calf.

Another object of the present invention is to provide a calf heating device that will allow a mother cow to form a bond with their newly born calf.

These and other objects, features or advantages of the present invention will become apparent from the specification and claims.

### BRIEF SUMMARY OF THE INVENTION

A calf warming device for warming a newborn calf has a housing with a base, sidewalls extending from the base, a door hingedly attached to a sidewall and a roof member. Thus, when the door is in a closed position the housing forms a cavity that is of size and shape to house a calf. Additionally, the base member has a heated surface that a calf may lay on for warming. The calf warming device additionally has at least one opening disposed through the housing that is of size and shape to accommodate a nose of a mother cow thus allowing the mother cow to smell her calf during the warming process while the door is in a closed position.

### BRIEF DESCRIPTION OF THE DRAWINGS

FIG. 1 is a perspective view of a calf warming device with a door in an open position;

FIG. 2 is a side view of a calf warming device with a door in a closed position; and

FIG. 3 is an end view of a calf warming device.

### DETAILED DESCRIPTION OF THE PREFERRED EMBODIMENT

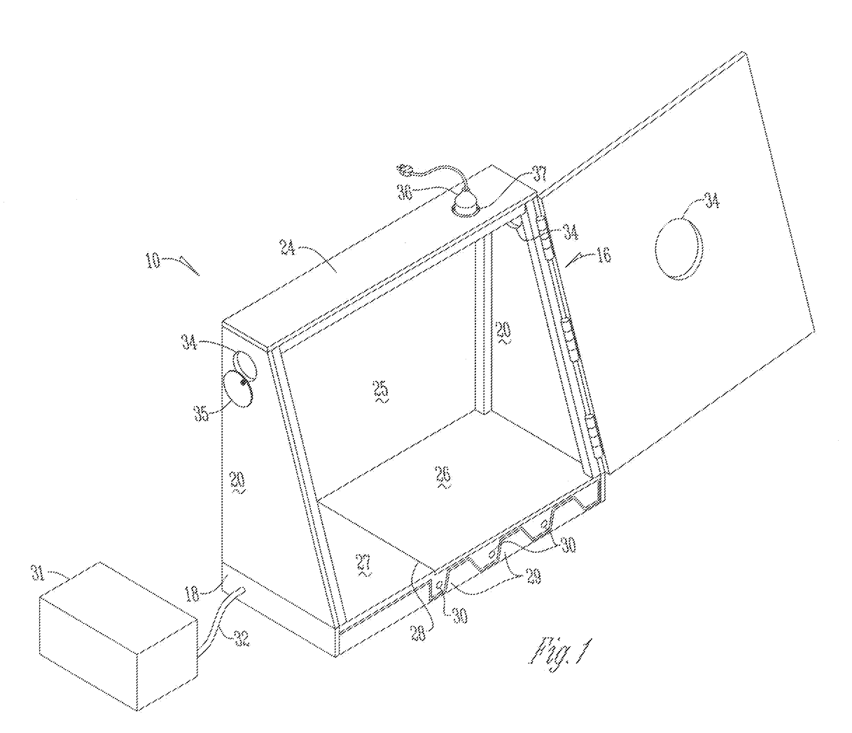

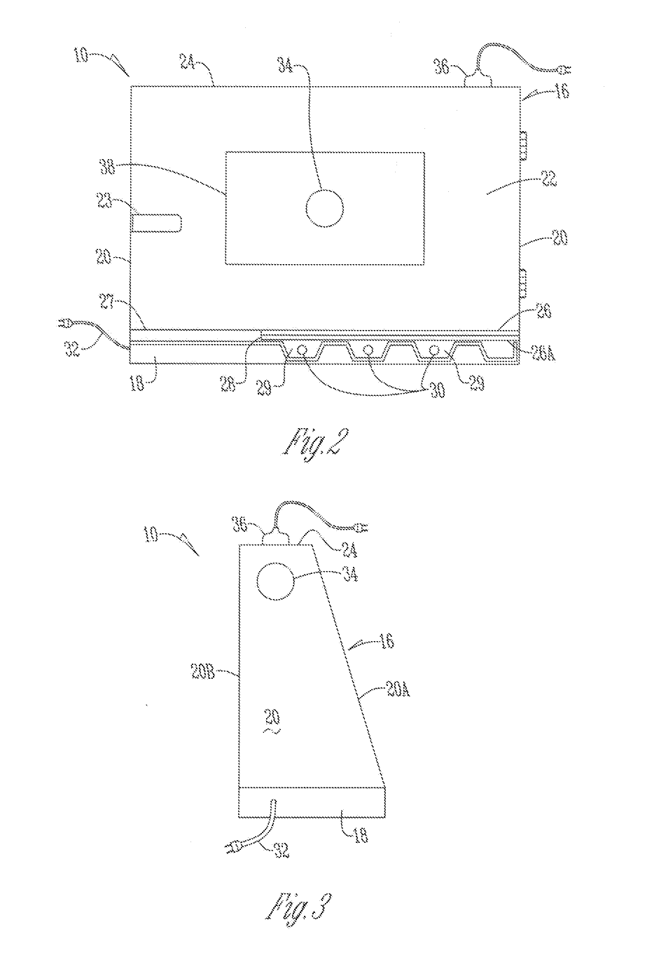

FIGS. 1 and 2 show a calf warming device 10 that allows the warming of a calf while also allowing a mother cow access to the baby calf for bonding. Specifically, the calf warming device 10 has a housing 16 having a base 18, a plurality of side walls 20 extending from the base 18, a door 22 hingedly connected to a sidewall 20 having a tapered portion 20A, straight portion 20B and a roof member 24. By having an angled sidewall easier access for the calf is provided along with a reduction in the volume of air to be heated. The door 22 in a preferred embodiment fits within a formed area recess in the housing to provide a more rigid structure wherein a calf can push its feet against a frame instead of the door 22. The door 22 also has a latch member 23 for opening and closing the door.

The base 18, sidewall 20 and roof member 24 form a cavity 25 of size and shape to accommodate a newborn calf and preferably is of one-piece construction such as molded plastic. At least one sidewall 20A is tapered inwardly from the base 18 to the roof member 24. The tapering of the sidewall 20A prevents the calf from standing while being warmed.

The base 18 comprises a heating element 26 that when actuated warms the calf. Preferably, the base 18 has a flat portion 27 and a recessed step portion 28 that receives the heating element 26 and prevents the heating element from sliding around while warming the calf. Below the flat portion 27 and the recessed step portion 28 are a plurality of corrugated ribs 29 that add to the structural integrity of the base 18. Alternatively, the ribs 29 have a flat top surface that forms the recessed step portion 28 to support the heating element 26. Disposed between the ribs 29 are a plurality of drainage holes 30 that facilitate cleaning of the warming device 10. The heating element 26 in a preferred embodiment is a heating pad and is electrically connected to a power source 31 such as a generator via a power line 32 that is disposed through a sidewall 20 or a rechargeable battery. Also, in a preferred embodiment an insulator board 26A is sandwiched between the heating element 26 and the ribs 29. Also, the insulator board is attached to one or more side walls to provide insulation from the wind. The insulator board 26A insulates the heating element 26 from coldness coming from the ground.

The sidewalls 20 optionally have scent openings 34 disposed therethrough that are of size and shape to allow the mother cow 14 to be able to smell the scent of her calf 12 within the cavity 25 of the housing 16. The scent opening may be closed by a cover member 35 rotatably and pivotally connected to a sidewall. By having a cover member 35 the scent openings 34 may be closed during poor weather conditions. Additionally, the roof member 24 has a heating element 36 disposed therethrough that in a preferred embodiment is a heating lamp. Specifically, the lamp can be placed in a recess 37 to hold the lamp in place.

The door 22, like the sidewalls 20, optionally can have a scent opening 34 disposed therein. Additionally, in one embodiment the door 22 has a transparent portion 38 wherein the scent opening 34 is disposed therethrough. The transparent portion 38 allows for the mother cow 14 to visibly see her calf 12 while also being able to smell the calf 12. Preferably, the transparent portion is made of Plexiglas®. In another embodiment the entire door is made of Plexiglas®.

In operation when a calf is born the calf warming device 10 and portable power source 31 are transported to the location where the mother cow's water broke. The calf is then placed within the cavity 25 on the heating element 26. Because sidewall 20A is angled the calf is unable to stand and is forced to lay down on the heating element 26. At this time the heating element 36 disposed through the roof 24 can be actuated to provide heat from above the calf 12. Once the calf 12 is in position the door 22 is placed in a closed position as shown to enclose the calf 12 within cavity 25.

When the door 22 is in a closed position (FIG. 2) the cow 14 is brought to the calf warming device so that the cow is able to see the calf 12 through at least the transparent portion 38 of the door 22. Additionally the cow 14 can stand adjacent to a scent opening 34 to smell her calf 12. Optionally, the cow may place its nose through the scent opening 34 to get a stronger smell of her calf 12.

Once the calf 12 is properly heated and ready to come out of the calf warming device 10 the door 22 is placed in an open position. Because the cow 14 recognizes both the scent and appearance of her calf 12 the cow 14 immediately cares for and nurses the calf 12. Once the calf 12 has exited the calf warming device 10 a veterinarian or user may clean out the interior of the housing 16 by spraying the interior with a hose wherein the water drains from the cavity 25 via the drainage openings 30.

Thus, disclosed is an improved calf warming device 10. The device allows a mother cow 14 to not only see but additionally smell her newborn calf to ensure she will take care of and nurse after the warming process. Additionally, the calf warming device heats the calf 12 without drying the calf by blowing air over the calf that causes cooling. Instead, a first heating element 26 that directly engages the calf 12 and a second heating element 36 above the calf work to warm the calf wherein as the calf warms the calf additionally dries. The calf warming device also has a corrugated bottom surface and drainage openings 30 to allow drainage for fast cleaning of the device. Additionally, because the calf warming device 10 and power source 31 are portable they can be taken to the place where the mother cow's water broke. Consequently, at the very least, all of the stated objectives have been met.

It will be appreciated by those skilled in the art that other various modifications could be made to the device without the parting from the spirit in scope of this invention. All such modifications and changes fall within the scope of the claims and are intended to be covered thereby.

What is claimed is:

1. A calf warming device comprising:
a housing having a base, sidewalls extending from the base, a door hingedly attached to a sidewall and a roof member wherein when the door is in a closed position the housing encloses a cavity of size and shape to house a calf;
said base having a heated surface for warming the calf;
at least one scent opening disposed through the housing of size and shape to allow a cow to smell the calf when the door is in a closed position.

2. The calf warming device of claim 1 wherein the door comprises a transparent portion.

3. The calf warming device of claim 1 wherein a scent opening is disposed through the door.

4. The calf warming device of claim 1 wherein a scent opening is disposed through a sidewall of the housing.

5. The calf warming device of claim 1 wherein at least one sidewall is angled from the base to a roof member.

6. The calf warming device of claim 1 further comprising a heat lamp disposed through an opening in the roof member.

7. The calf warming device of claim 1 further comprising a power source electrically connected to a pad portion of the base that heats the heated surface of the base.

8. The calf warming device of claim 1 wherein the housing is made of a transparent material.

9. A method of warming a calf, steps comprising:
providing a housing having a base, sidewalls extending from the base, a door hingedly attached to a sidewall and a roof member wherein when the door is in a closed position the housing encloses a cavity of size and shape to house a calf;
providing a scent opening disposed through the housing;
heating a heated surface of the base;
placing a calf within the cavity and closing the door to warm the calf; and
allowing a nose of a cow to be adjacent the scent opening to allow the cow to smell the calf.

10. The calf warming device of claim 9 further comprising the step of allowing the nose of the cow to be disposed through the scent opening.

11. The calf warming device of claim 9 further comprising the step of heating the calf via a heat lamp disposed through an opening in the roof member.
